(19) United States
(12) Patent Application Publication
(10) Pub. No.: US 2023/0211849 A1
(43) Pub. Date: Jul. 6, 2023

(54) Motorcycle to Trike Conversion Swingarm Device

(71) Applicants: Gene Mancini, Friendsville, PA (US); Julia Mancini, Friendsville, PA (US)

(72) Inventors: Gene Mancini, Friendsville, PA (US); Julia Mancini, Friendsville, PA (US)

(21) Appl. No.: 18/148,158

(22) Filed: Dec. 29, 2022

Related U.S. Application Data
(60) Provisional application No. 63/294,928, filed on Dec. 30, 2021.

(51) Int. Cl. B62K 11/02; B62K 13/08

(52) U.S. Cl. CPC B62K 11/02; B62K 13/08

(57) ABSTRACT

The present invention relates generally to the field of motorcycle to trike conversions. More specifically, the present invention relates to a motorcycle to trike conversion swingarm device that is primarily comprised of a frame further comprised of a first end and a second end. The device can be used to convert a softail motorcycle into a trike and provides a more visually appealing design line to the trike after assembly. The swingarm device, in different embodiments, is designed to fit different types of axle mounts.

### CROSS-REFERENCE TO RELATED APPLICATION

The present application claims priority to, and the benefit of, U.S. Provisional Application No. 63/294,928, which was filed on Dec. 30, 2021, and is incorporated herein by reference in its entirety.

### FIELD OF THE INVENTION

The present invention relates generally to the field of motorcycle to trike conversions. More specifically, the present invention relates to a motorcycle to trike conversion swingarm device that is primarily comprised of a frame further comprised of a first end and a second end. The device can be used to convert a softail motorcycle into a trike and provides a more visually appealing design line to the trike after assembly. Accordingly, the present disclosure makes specific reference thereto. Nonetheless, it is to be appreciated that aspects of the present invention are also equally applicable to other like applications, devices, and methods of manufacture.

### BACKGROUND

Currently available internally mounted trike swingarms for softail motorcycles do not allow for clean style lines due to the clearance required to swing inside the frame. Said existing design lines limit the customization ability of softail motorcycles. Motorcycle owners may also be interested in new ways to alter their motorcycle with ease.

Therefore, there exists a long-felt need in the art for a device that overcomes the limitations of currently available internally mounted trike swingarms for softail motorcycles. There also exists a long-felt need in the art for a motorcycle to trike conversion swingarm device that provides more aesthetically appealing style lines. Further, there exists a long-felt need in the art for a motorcycle to trike conversion swingarm device that is compatible with softail system motorcycles.

The subject matter disclosed and claimed herein, in one embodiment thereof, comprises a motorcycle to trike conversion swingarm device. The device is primarily comprised of a frame comprised of a first end and a second end. The device can be used to convert a softail motorcycle into a trike. The first end is further preferably comprised of two rockers and an inner swingarm. The second end is further comprised of two sets of rear axle mounts. The shape of the frame of the device provides a more visually appealing design line after assembly.

In this manner, the motorcycle to trike conversion swingarm device of the present invention accomplishes all of the foregoing objectives and provides a device that overcomes the limitations of currently available internally mounted trike swingarms for softail motorcycles. To do so, the device provides more aesthetically appealing style lines. In addition, the device is compatible with softail system motorcycles, making it versatile in application.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorcycle to trike conversion swingarm device. The device is primarily comprised of a frame comprised of a first end and a second end. The first end is further comprised of at least one rocker. The frame preferably has two rockers that are parallel and spaced apart. At least one inner swingarm is located between the parallel rockers and acts as a spacer.

The device also preferably has at least one bearing on each side of the inner swingarm. The bearings are preferably positioned between the inner swingarm and each rocker. The first end may further be comprised of a shock mount. In addition, each rocker may be comprised of at least one pivot shaft opening.

The second end of the frame is comprised of at least one axle mount fork located on at least one mounting plate. The frame preferably has four axle mount forks arranged in sets of two on each side of the frame (i.e., in line with each rocker). The first set of two axle mount forks is then spaced apart and parallel to the second set of two axle mount forks.

The frame is also comprised of at least one frame arm and at least one axle mount brace. The frame arms preferably connect each rocker to each mounting plate on each side of the frame. The axle mount braces may support the frame and may connect to each frame arm on each side of the frame or connect each set of frame arms across the frame horizontally.

Accordingly, the motorcycle to trike conversion swingarm device of the present invention is particularly advantageous as it provides more aesthetically appealing style lines for softail motorcycle to trike conversions. In this manner, the motorcycle to trike conversion swingarm device overcomes the limitations of existing trike conversion devices known in the art which are visually unappealing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a motorcycle to trike conversion swingarm device of the present invention in accordance with the disclosed architecture; and

FIG. 2 illustrates a front view of one potential embodiment of a motorcycle to trike conversion swingarm device of the present invention in accordance with the disclosed architecture;

FIG. 3 illustrates side perspective view of another potential embodiment of the trike conversion swingarm device of the present invention in accordance with the disclosed architecture;

FIG. 4 illustrates top perspective view of the trike conversion swingarm device of FIG. 3 in accordance with the disclosed architecture;

FIG. 5 illustrates a close view of the two-piece interchangeable axle mounts used in the trike conversion swingarm device of FIG. 3 in accordance with the disclosed architecture;

FIG. 6 illustrates a side perspective partial view showing the trike conversion swingarm device of the present invention mounted to a motorcycle in accordance with the disclosed architecture;

FIG. 7 illustrates a top perspective view of one potential embodiment of the trike conversion swingarm device of the present invention showing shock absorbers in accordance with the disclosed architecture;

FIG. 8 illustrates another embodiment of the motorcycle to trike conversion swingarm device of the present invention in accordance with the disclosed architecture;

FIG. 9 illustrates yet another embodiment of the trike conversion swingarm device of the present invention in accordance with the disclosed architecture; and

FIG. 10 illustrates a potential arrangement of pivot and bearing for connecting inside of a pivot to a swingarm and for connecting the swingarm to the rear of a motorcycle in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that overcomes the limitations of currently available internally mounted trike swingarms for softail motorcycles. There also exists a long-felt need in the art for a motorcycle to trike conversion swingarm device that provides more aesthetically appealing style lines. Further, there exists a long-felt need in the art for a motorcycle to trike conversion swingarm device that is compatible with softail system motorcycles.

The present invention, in one exemplary embodiment, is comprised of a motorcycle to trike conversion swingarm device. The device is primarily comprised of a frame further comprised of a first end and a second end and can be used to convert a softail motorcycle into a trike. More specifically, the first end is preferably comprised of two rockers and an inner swingarm. The second end is further comprised of two sets of rear axle mounts. The shape of the frame of the device provides a more visually appealing design line after assembly.

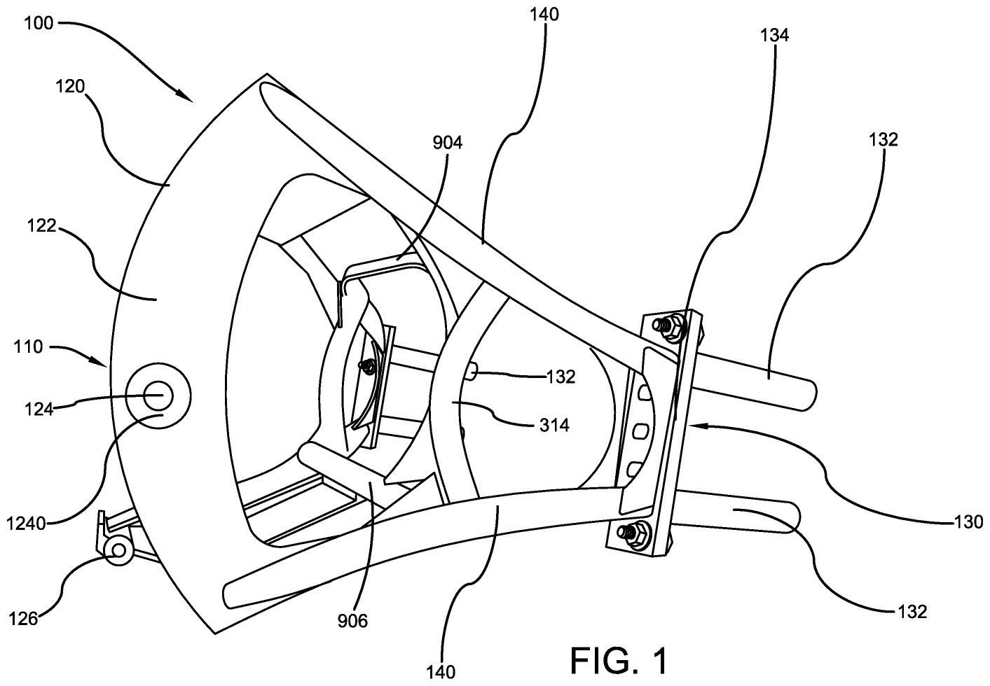

Referring initially to the drawings, FIG. 1 illustrates a side view of one potential embodiment of a motorcycle to trike conversion swingarm device 100 of the present invention in accordance with the disclosed architecture. The device 100 is primarily comprised of a frame 110 comprised of a first end 120 and a second end 130. All components of the device 100 are preferably manufactured from a durable metal material such as, but not limited to, stainless steel, brass, copper, aluminum, etc. The material may further have a plurality of finishes, such as, but not limited to, brushed, hammered, polished, satin, oil-rubbed, etc.

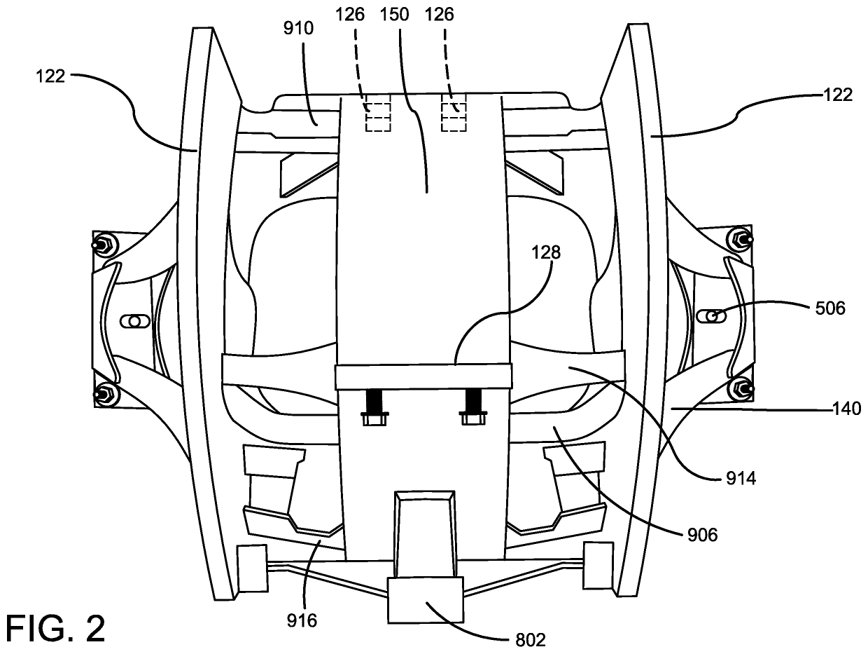

The first end 120 is comprised of at least one rocker 122. In the preferred embodiment, the frame 110 has two rockers 122 that are parallel and spaced apart. At least one spacer tab 128,924 is located between the parallel rockers 122, as best seen in FIG. 2. The tab 128 preferably attaches to at least one central frame member 150 that provides support for the tab 128, and to the frame 110 as a whole. In one embodiment, the device 100 has at least one bearing 1240. In the preferred embodiment, the device 100 has at least one bearing 1240 on each side of the tab 128, or spacer 922 wherein the bearings 1240 are positioned between the tab 128, or spacer 922 and each rocker 122. In one embodiment, the bearings 1240 may be captured either on both rockers4 122, the tab 128, or another portion of the frame 110. The first end 120 may further be comprised of a shock mount 126. Further, each rocker 122 may be comprised of at least one pivot shaft opening 124 or one pivot bearing bore 928.

The second end 130 of the frame 110 is comprised of at least one axle mount fork 132. In the preferred embodiment, the frame 110 has four axle mount forks 132. The axle mount forks 132 are preferably arranged in sets of two on each side of the frame 110 (i.e., in line with each rocker 122) and wherein each set is attached to at least one mounting plate 134. In a set, the axle mount forks 132 are preferably arranged such that one axle mount fork 132 of the set is parallel and positioned directly above the other axle mount fork 132 of the set. The first set of two axle mount forks 132 is then spaced apart and parallel to the second set of two axle mount forks 132.

The frame 110 is comprised of at least one frame arm 140 and at least side rail brace 314. In the preferred embodiment, the device has at least one frame arm 140 that connects each rocker 122 to each mounting plate 134 on each side of the frame 110. The side rail brace 314 may support the frame 110 and may connect to each frame arm 140 on each side of the frame or connect each set of frame arms 140 across the frame horizontally.

The swingarm device 100 is configured to attach to the rear of a motorcycle using a pivot shaft opening 124 or pivot bearing bore 928 and terminate with mounts for the axle at the rear end 130 using axle mount forks 132. In differing embodiments, the swingarm has shock absorber mounts that connect to the existing shock absorbers of the motorcycle. It should be noted that the pivot 124 acts as the fulcrum, the shock absorbers as the load and axle mount fork 132 as the effort end.

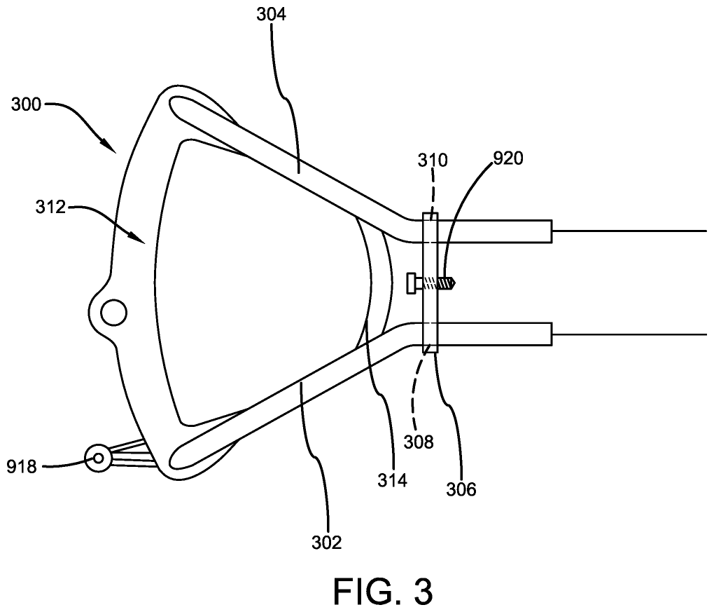

FIG. 3 illustrates a left perspective view of another potential embodiment of the trike conversion swingarm device of the present invention in accordance with the disclosed architecture. In the present embodiment, the one-piece side rail 300 is configured to have inward bent side rails 302,304, such as shown wherein the side rails 302,304 run through the axle mount brace 306 positioned near the rear of the axle mount tubes. More specifically, the axle mount brace 306 has a first hole 308 allowing the first side rail 302 to pass through and a second hole 310 allowing the second side rail 304 to pass through.

It should be noted that the rails 302,304 used in the present embodiment are continuous tubes and require no gussets for a secure connection. The inward bent side rails 302,304 are designed to fit with motorcycles that are not compatible with the outward bent side rails. Other material and construction details of the swingarm 300 may remain like the other embodiments described in the disclosure.

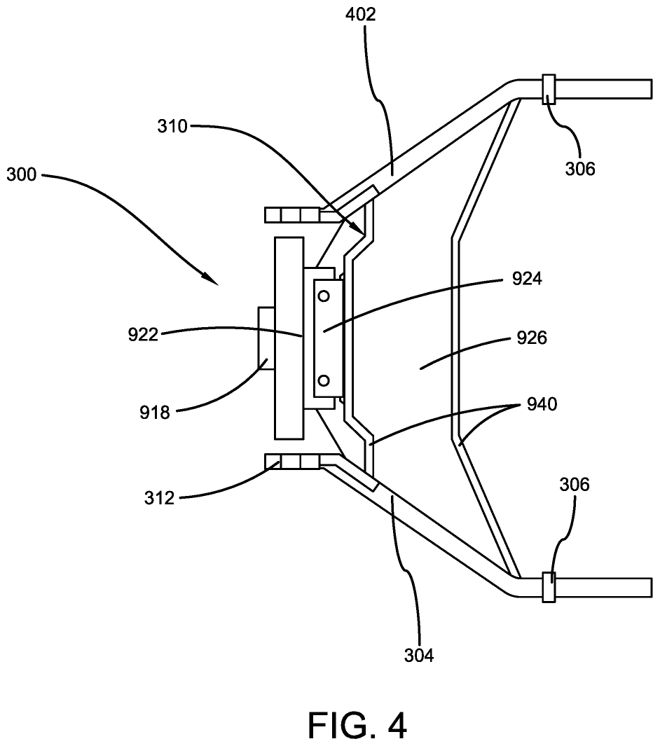

The one-piece side rail 300 has a pair of mirrored inward bent side rails 302,304 on the opposite side of the one-piece side rail 300 and has the same specifications and construction, wherein the rails 302,304 on the opposite side are used for coupling to the opposite side of the trike axle which the swingarm 300 is detachably attached. The inward bent orientation of the side rail 304 and the corresponding opposite side rail 402 are shown in top perspective view of the one-piece side rail 300 in FIG. 4. Like the structure of swingarm 100, the one-piece side rail 300 also has a rocker 312 and axle mount brace 306. Other structural specifications of the one-piece side rail 300 can be similar to the swingarm 100.

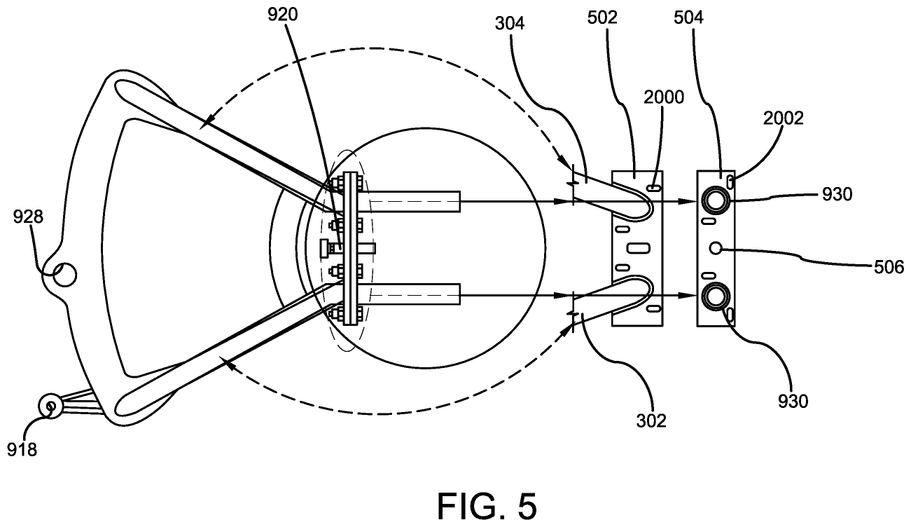

FIG. 5 illustrates a close view of the two-piece interchangeable axle mounts used in the FIG. 1, 2 in accordance with the disclosed architecture. As illustrated, when a two-piece axle mount is used with each inward bent side rail, a plate 502 along with a substantially similar dimensioned axle mount 504 is used for securing the side rails 302,304. The plate 502 and the mount 504 are fastened through slotted holes. In some embodiments of the one-piece side rail 300 of the present invention, the axle mount 504 can be solid with no separate plate and axle mount, as per preferences of a user.

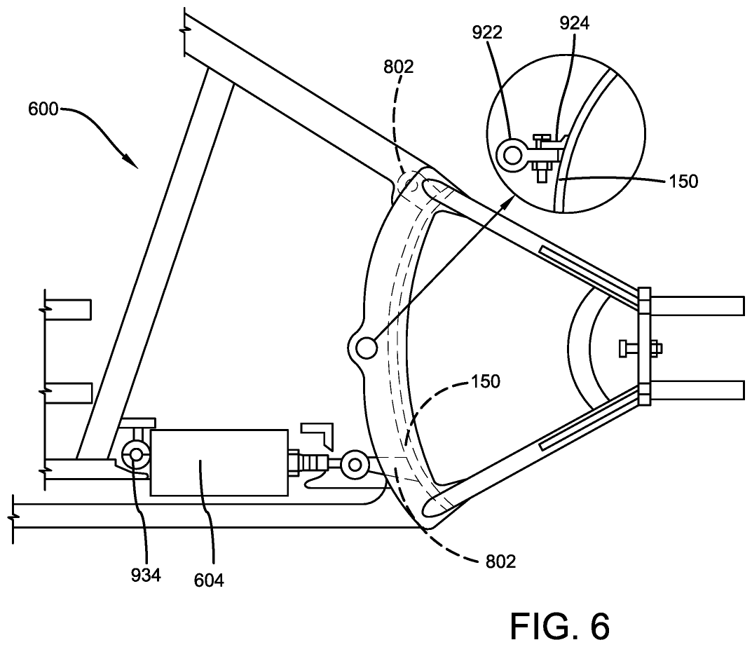

FIG. 6 illustrates a side perspective partial view showing the trike conversion swingarm device 100 of the present invention mounted to a motorcycle frame in accordance with the disclosed architecture. As illustrated, the rear shock mount 802 of the swingarm 100 is coupled to the shock absorber 604 of the motorcycle frame 600. It should be noted that the shock absorber 604 is also connected to the shock mount (not visible inside of 934) on the motorcycle.

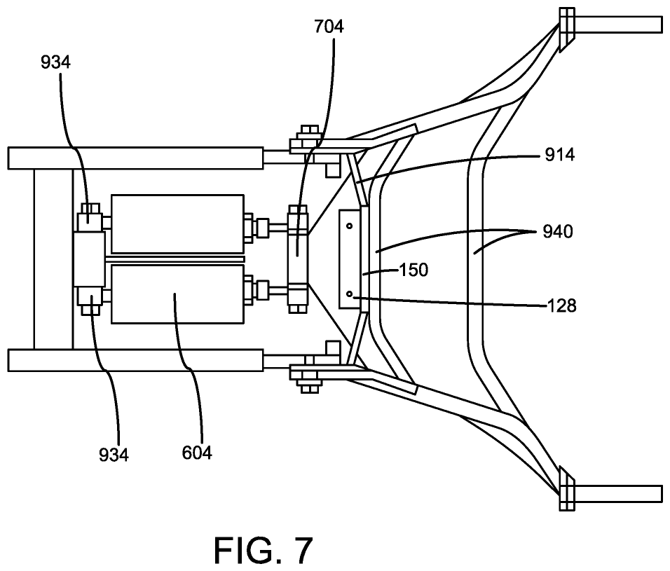

FIG. 7 illustrates a top perspective view of one potential embodiment of the trike conversion swingarm device 100 of the present invention showing shock absorbers in accordance with the disclosed architecture. As illustrated, at least one shock absorber 604 is connected to at least one rear shock mounts 704 respectively positioned on either side of the shock mount 704. The shocks are extension type shocks such that they extend under dampened spring loading when the axle travels up and retracts when the axle travels down providing suspension at the rear of the motorcycle.

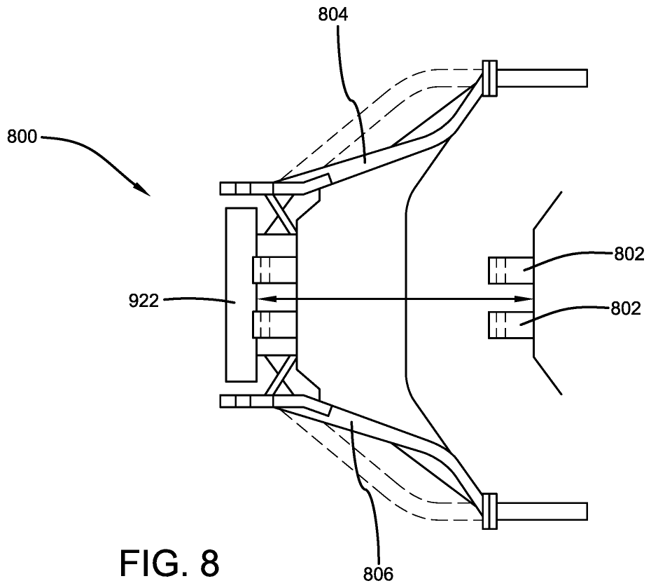

FIG. 8 illustrates another embodiment of the motorcycle to trike conversion swingarm device 100 of the present invention in accordance with the disclosed architecture. The swingarm device 800 of the present embodiment is designed to have a shock mount 802 positioned at the top of swingarm on the central frame member 150 (or top front cross member 910) and is especially designed for single compression type shocks. The shock mount 802 may connect to the shock absorber of the motorcycle in a manner as described in FIGS. 6 and 7. The shock mount 802 may be drilled to fit a shock pin or bolt to fix to a shock absorber.

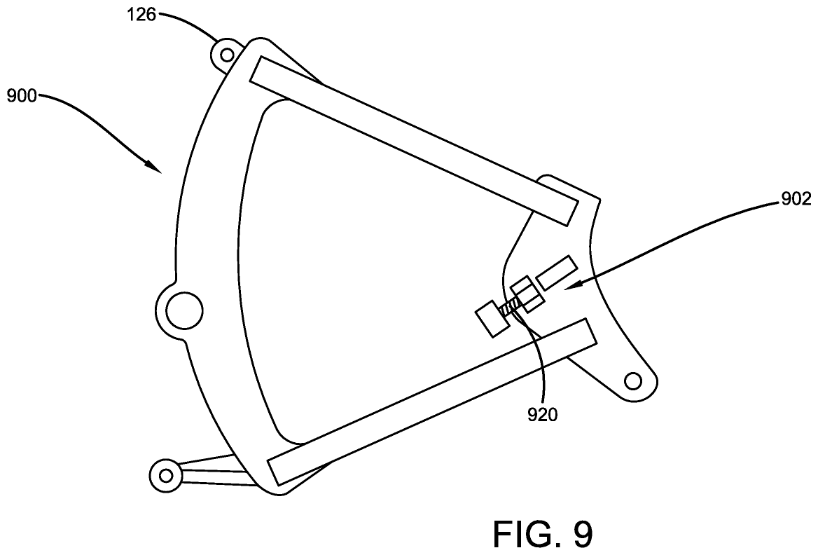

FIG. 9 illustrates yet another embodiment of the trike conversion swingarm device 100 of the present invention in accordance with the disclosed architecture. In the present embodiment, the swingarm device 900 is configured to have Frankenstein style axle mounts 902 such that center spacing between the axle mounts on the opposite side rails is closer than conventional DNA style axle mounts.

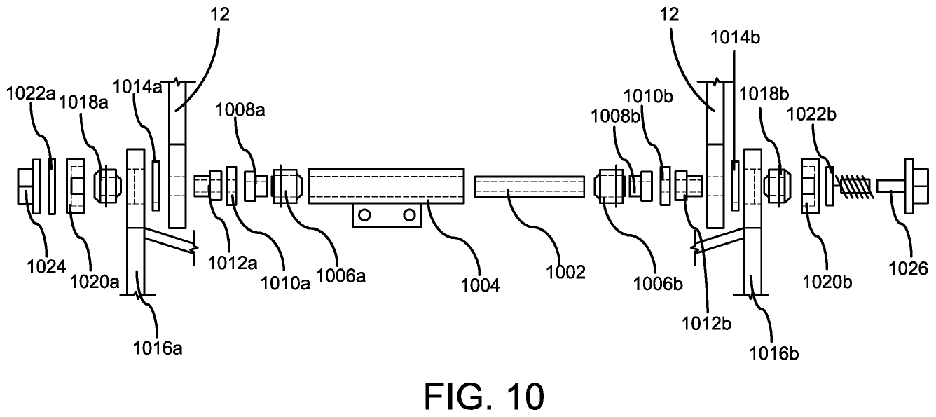

FIG. 10 illustrates a potential arrangement of pivot and bearing for connecting inside of a pivot to a swingarm and for connecting the swingarm to the rear of a motorcycle frame 12 in accordance with the disclosed architecture. As illustrated, an inner bearing spacer 1002 configured to be enclosed inside a spacer 1004 is provided. On both sides of the spacer 1004, the inside bearing 1006a,1006b are positioned along with inside bearing bushings 1008a,1008b. A pair of inside shims 1010a,1010b are used for coupling the inside bearing bushings 1008a,1008b and the outside bearing bushings 1012a,1012b.

For secure connections, a pair of frame to swingarm clearance shims 1014a,1014b are positioned between two swingarm rockers 1016a,1016b and motorcycle frame 12. For outside connections, a pair of outside softail bearings 1018a,1018b and bearing covers 1020a,1020b are positioned. Finally, for sealing copper washers 1022a,1022b, a pivot nut 1024 and a pivot bolt 1026 are used.

The device 100 is also comprised of a connector 914 and a bottom rear cross member 906. The members 914,906 are preferably removable for belt drive installation. Connectors 914 connect to rockers 122 to each other or to central frame member 150. The bottom rear cross member 906 connects to the bottom side rails 302 to provide structural support.

A top plate 926 is used to brace the top side rails 304,804 horizontally. Although, in one embodiment the device 100 may lack a top plate 926 if large enough tubing and gussets are used for the cross members 904,906, 910, 914,916. The device 100 is also comprised of at least one pivot bearing bore that accepts pivot bearings.

The device 100 also has a rear shock mount 802,126,918,704 allow for the attachment of motorcycle shocks. The device 100 is also comprised of at least one horizontal slotted hole 2000 for mounting the axle mount plate 504 and providing adjustment of trike angle and at least one vertical slotted hole 2002 (found on the end of the axle mount fork 930) that allows for mounting to plate 502 and provides vertical adjustment of trike axle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorcycle to trike conversion swingarm device”, “swingarm”, “trike conversion swingarm device”, and “device” are interchangeable and refer to the motorcycle to trike conversion swingarm device 100,300,800,900 of the present invention.

Notwithstanding the foregoing, the motorcycle to trike conversion swingarm device 100,300,800,900 of the present invention and its various components can be of any suitable size and configuration as is known in the art without affecting the overall concept of the invention, provided that they accomplish the above-stated objectives. One of ordinary skill in the art will appreciate that the size, configuration, and material of the motorcycle to trike conversion swingarm device 100,300,800,900 as shown in the FIGS. are for illustrative purposes only, and that many other sizes and shapes of the motorcycle to trike conversion swingarm device 100,300,800,900 are well within the scope of the present disclosure. Although the dimensions of the motorcycle to trike conversion swingarm device 100,300,800,900 are important design parameters for user convenience, the motorcycle to trike conversion swingarm device 100,300,800,900 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorcycle to trike conversion swingarm device comprising:
a frame;
a first end with an rocker; and
a second end with a axle mount fork.

2. The motorcycle to trike conversion swingarm device of claim 1, wherein the outer swing arm connects to the axle mount fork via a frame arm.

3. The motorcycle to trike conversion swingarm device of claim 2, wherein the frame arm attaches to a mounting plate that is attached to the axle mount fork.

4. A motorcycle to trike conversion swingarm device comprising:
a frame;
a first end with an rocker and an inner swingarm; and
a second end with a set of axle mount forks and a mounting plate.

5. The motorcycle to trike conversion swingarm device of claim 4, wherein the set of axle mount forks is comprised of a first axle mount fork and a second axle mount fork.

6. The motorcycle to trike conversion swingarm device of claim 5, wherein the first axle mount fork is positioned above the second axle mount fork.

7. The motorcycle to trike conversion swingarm device of claim 6, wherein the first axle mount fork and the second axle mount fork are parallel.

8. The motorcycle to trike conversion swingarm device of claim 4, wherein the frame is further comprised of a bearing.

9. The motorcycle to trike conversion swingarm device of claim 8, wherein the bearing is positioned between the inner swingarm and the rocker.

10. A motorcycle to trike conversion swingarm device comprising:
a frame;
a bearing;
a first end with a pair of rockers having a first rocker and a second rocker, and an inner swingarm; and
a second end with a axle mount fork and a mounting plate.

11. The motorcycle to trike conversion swingarm device of claim 10, wherein the bearing is positioned within the frame.

12. The motorcycle to trike conversion swingarm device of claim 10, wherein the first rocker and the second rocker are parallel.

13. The motorcycle to trike conversion swingarm device of claim 10, wherein the axle mount fork attaches to the mounting plate.

14. The motorcycle to trike conversion swingarm device of claim 13, wherein the mounting plate attaches to a frame arm.

15. The motorcycle to trike conversion swingarm device of claim 14, wherein the frame arm attaches to the first outer swing arm.

16. The motorcycle to trike conversion swingarm device of claim 10, wherein the inner swingarm is positioned between the first rocker and the second rocker.

17. The motorcycle to trike conversion swingarm device of claim 10, wherein the motorcycle to trike conversion swingarm device is comprised of a axle mount brace.

18. The motorcycle to trike conversion swingarm device of claim 17, wherein the axle mount brace attaches to the frame arm.

19. The motorcycle to trike conversion swingarm device of claim 10, wherein the motorcycle to trike conversion swingarm device is comprised of a shock mount.

20. The motorcycle to trike conversion swingarm device of claim 10, wherein the rocker is further comprised of a pivot shaft opening.
